(19) United States
(12) Patent Application Publication
(10) Pub. No.: US 2021/0146264 A1
(43) Pub. Date: May 20, 2021

(54) VIRTUAL HYPERREALITY AMUSEMENT APPARATUS

(71) Applicant: NUNC-AMET HOLDING S.A., Luxemburg (LU)

(72) Inventors: Grigori Vladimirovich SHEVTSOV, Berdsk (RU); Yuri Andreevich BEDRIN, Novosibirsk (RU); Aleksei Igorevich Manankov, Novosibirsk (RU); Vadim Gennadevich Povetkin, Kaluzhskaya oblast' (RU); Konstantin Igorevich Kopyrin, Moskovskaya oblast' (RU)

(21) Appl. No.: 17/097,319

(22) Filed: Nov. 13, 2020

Related U.S. Application Data
(60) Provisional application No. 62/935,160, filed on Nov. 14, 2019.

(51) Int. Cl. A63G 31/16; A63F 13/90

(52) U.S. Cl. CPC A63G 31/16; A63F 2300/8082; A63F 13/90

(57) ABSTRACT

A virtual hyper-reality apparatus that has a frame with a first stand and a second stand. The first stand has a first gearbox with a first shaft. The second stand has a first axle. The apparatus also has an outer ring that is mounted between the first shaft and the first axle. The outer ring has a second shaft and a top axle mounted opposite to the second shaft. In addition, the apparatus has a middle ring that is mounted between the second shaft and the top axle. The middle ring has a second gearbox with a third shaft and a third axle positioned opposite to the third shaft of the middle ring. A cabin for a user is also provided and mounted between the third axle and the third shaft. The apparatus is configured to rotate the user 360 degrees in three planes, independently.

### BACKGROUND

The present invention generally relates to amusement and/or simulation apparatuses. More specifically, the present invention relates to a virtual hyper-reality apparatus where a user can rotate 360 degrees in three planes, independently.

Various amusement rides have been created to provide passengers with unique motion and visual experiences. For example, roller coasters and theme rides can be implemented with multi-passenger or a single passenger vehicle that travel along a fixed path. In addition to the speed or change in direction of the vehicle as they move along the path, the vehicles themselves may generate special effects, e.g., sound and/or motion effects

In another example, certain rides may be implemented with projection elements to create varying scenery and movement as the passenger vehicles travel along the path. However, it is now recognized that regardless of such enhancements to these passenger vehicle rides, the rider in the passenger vehicle may not feel immersed in the ride.

In yet another example, certain rides may combine an apparatus with the simulation of movements of an aircraft that does not ravel along a fixed path, but rather rotates in 360 degree directions to stimulate ascent, decent and rotational direction of an aircraft. These movements can be classified as being made about one or more of three axes of rotation. These axes are called longitudinal, normal (sometimes referred to as the vertical axis) and lateral.

However, users of these rides are generally aware of being within a ride, in part due to confines and limitations of the apparatuses. For example, the user may not be properly position within the apparatus or the apparatus may lack an ability to properly rotate the user to fully experience the ride or simulation. Accordingly, there is a need for an improved virtual hyper-reality apparatus that can stimulate certain experiences and/or simulate reality of movement.

### SUMMARY

In one aspect, the present invention provides a virtual hyper-reality apparatus that has a frame with a first stand and a second stand. The first stand has a first gearbox with a first shaft. The second stand has a first axle. The apparatus also has an outer ring that is mounted between the first shaft and the first axle. The outer ring has a second shaft and a top axle mounted opposite to the second shaft. In addition, the apparatus has a middle ring that is mounted between the second shaft and the top axle. The middle ring has a second gearbox with a third shaft and a third axle positioned opposite to the third shaft of the middle ring. A cabin for a user is also provided and mounted between the third axle and the third shaft. The apparatus is configured to rotate the user 360 degrees in three planes, independently.

In another aspect, the present invention provides a virtual hyper-reality apparatus for a motion simulation. The apparatus has a frame, an outer ring operably mounted on top of the frame and configured to rotate around the vertical axis and a middle ring operably mounted within the outer ring and configured to rotate around the horizontal axis. In addition, the apparatus has a cabin for a user operably mounted within the middle ring configured to rotate 360 degrees in three planes, independently.

### BRIEF DESCRIPTION OF THE DRAWINGS

In order for the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, aspects of the invention will be described and explained with additional specificity and detail through the use of the accompanying drawings.

FIG. 1A depicts a virtual hyper-reality apparatus in accordance to embodiments of the invention;

FIG. 1B depicts a cross-section view “C-C” of the apparatus shown in FIG. 1A in accordance with embodiments of the invention;

FIG. 1C depicts a cross-section view “E-E” of the apparatus shown in FIG. 1A in accordance with embodiments of the invention;

FIG. 1D depicts a cross-section view “D-D” of the apparatus shown in FIG. 1A in accordance with embodiments of the invention;

FIG. 1E depicts a cross-section view “F-F” of the apparatus shown in FIG. 1A in accordance with embodiments of the invention;

FIG. 2 depicts an exploded view of the apparatus shown in FIG. 1A as “B” in accordance with embodiments of the invention;

FIG. 3 depicts another exploded view of the apparatus shown in FIG. 1A as “A” in accordance with embodiments of the invention; and

FIG. 4 depicts a flow diagram illustrating a control system according to embodiments of the invention.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

Certain existing motion simulator rides may not be suitable for simulating certain motions, such as the feeling of riding an aircraft, motorcycling, or combat robot. For example, certain motion simulator rides may be housed within a stationary pods or positioned on stationary platforms that limit effects of movements, tilts, turns or other stimuli that effect a rider of an aircraft, motorcycling, or a combat robot.

Due to the configuration of certain motion simulator rides, a position of a display screen that displays a simulated environment during operation of the motion simulator ride may not be suitable for simulating the feeling of riding (e.g., an aircraft, motorcycling, or combat robot). For example, certain motion simulator rides may have a domed projection screen that displays the simulated environment positioned above the motion simulator rides. Therefore, it may be difficult to create a feeling of riding or controlling an aircraft, motorcycling, or combat robot because the user does not view the environment in a more natural and comfortable gaze position (e.g., generally straight ahead to generally downward) as one would be if they were riding a motorcycle, for example.

Accordingly, provided herein is a virtual hyper-reality apparatus having a system of rings operably connected to a cabin that allows a user to rotate 360 degrees in three planes, independently, and experience the feeling of riding, for example, an aircraft, motorcycling, or combat robot through movements of pitch, roll and yaw in addition to vertical ascent and descent.

In embodiments of the present invention, the virtual hyper-reality apparatus can include a cabin, a frame, a middle ring with a horizontal axis of rotation, and an outer ring with outer vertical axis of rotation. The apparatus can also include a control system to facilitate and synchronize the spatial position of the axes (X, Y, Z) of the apparatus with a virtual spatial position of a user in a content at a given point in time.

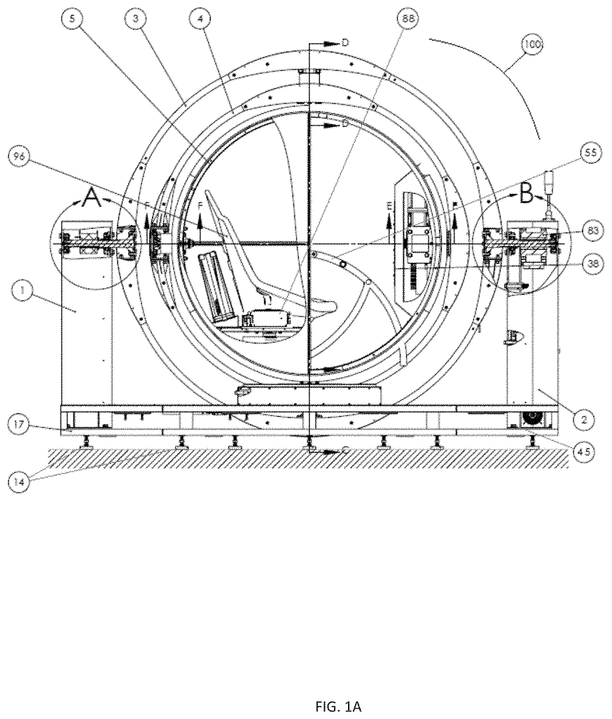

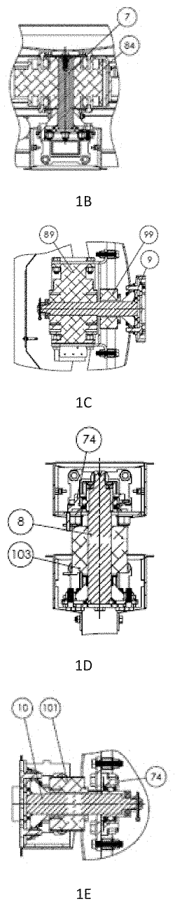

FIGS. 1A to 3 illustrate a virtual hyper-reality apparatus 100 according to embodiments of the present invention. As illustrated in FIG. 1, the apparatus 100 includes a cabin 5, a frame 17, a middle ring 4 and an outer ring 3. The frame 17 includes a first (right) stand 1 and a second left stand 2. The first (right) and the second (left) stands 1, 2 are fixed on the frame 17 by (suitable fastener, for example, hex bolts. The first and the second stands 1, 2 can be supported by a plurality of tensioners (not shown), preferably, at least from three of the four sides of each stands 1, 2. This reduces vibration and oscillatory movement of the stands.

The frame 17 can also include a plurality of movable platforms (not shown) that can mechanically fix the outer ring 3 in a “start” position thereby allowing a user to enter the cabin 5. The frame 17 can also include a plurality of supports 14 for additional stability of the frame 17.

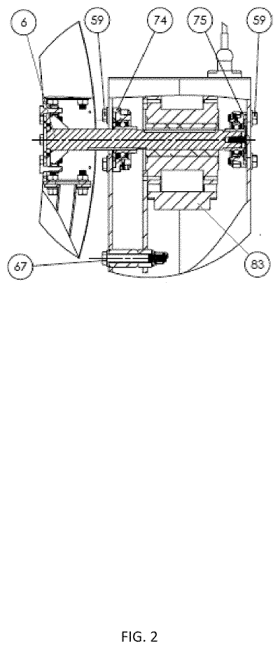

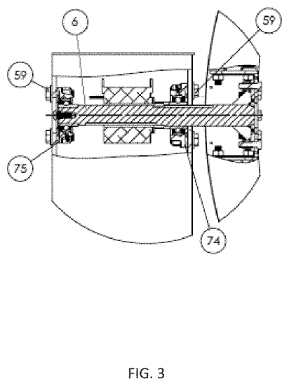

FIGS. 2 and 3, which are exploded views of “A” and “B,” respectively, of FIG. 1A, illustrate the outer ring 3 configuration and arrangement of the first and the second stands 1, 2. The outer ring 3 is installed on bearing assemblies 74, 75 (shown in FIGS. 2 and 3), which are mounted on the first and second stands 1, 2.

As shown in FIGS. 1A and 2, according to embodiments of the present invention, the stand 2, can include a first gearbox 83 and a shaft 6 (shown in FIG. 2), Through a key (not shown) the first gearbox 83 transmits torque to the shaft 6, fixed on the outer ring 3.

As shown in FIG. 3, according to embodiments of the present invention, the stand 1 can include an axle 6 installed in bearing assemblies 74, 75. The axle bis fixed to the outer ring 3 through, for example, a bolted connection.

As shown in FIG. 1A, according to embodiments of the present invention, the outer ring 3 is vertically position in relation to the frame 17.

As shown in FIG. 1D, according to embodiments of the present invention, the outer ring 3 further includes a top axle 8 (also shown in FIG. 1D). The top axle 8 is mounted opposite to a second shaft 7 (shown in FIG. 1B) of the outer ring 3. The second shaft 7 is located within a second gearbox 84 (shown in FIG. 1B). A first current collector 103 (as shown in FIG. 1D is installed on the top axle 8 (shown in FIG. 1D).

According to embodiments of the present invention, the outer ring 3 can include arches and coupling boxes, and can be made from steel or aluminum alloy or any other suitable material.

As shown in FIGS. 1A-1E, according to embodiments of the present invention, the middle ring 4 is mounted by any suitable means on the second shaft 7 (which is configured within the second gearbox 84 (shown in FIG. 1B)) and positioned on the middle ring 4 and the top axle 8. A side gearbox 89 (as shown in FIG. 1C) located on the cabin 5 in frontal position to the user. A third shaft 9 (shown in FIG. 1C) is fit in the side gearbox 89. A third axle 10 (shown in FIG. 1E) is mounted opposite the third shaft 9 on the middle ring 4. A second current collector 101 (shown in FIG. 1E) is fixed on the third axle 10. Ad third current collector 99 (shown in FIG. 1C) is fixed on the third shaft 9. The side gearbox 89 transmits torque in the horizontal plane relative to the middle ring 4.

As shown in FIGS. 1A-1E the cabin 5 is mounted on the third axle 10 and the third shaft 9 thereby allowing the cabin 5 to rotate in the horizontal plane. The cabin 5 can include a seat 96.

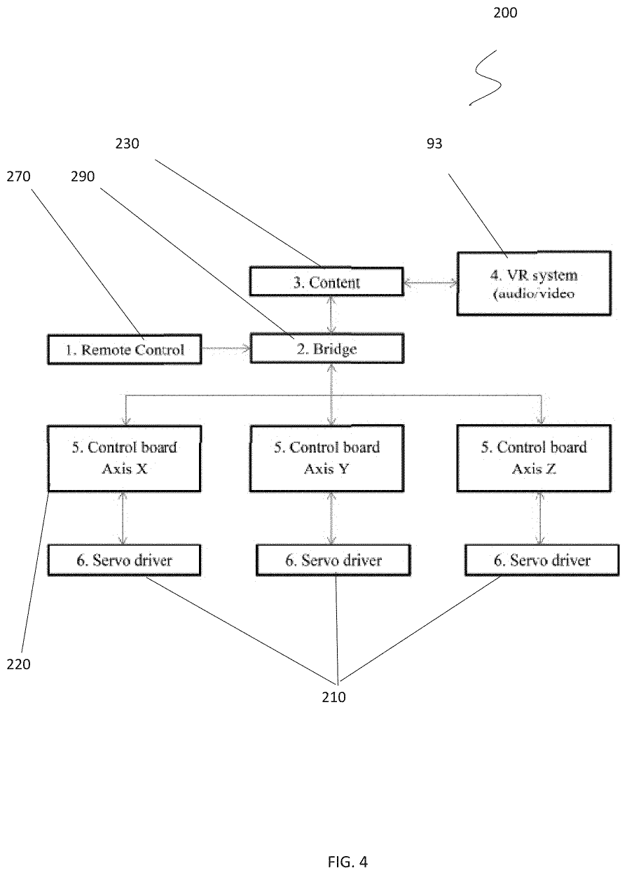

The apparatus 100 can also include an operator panel (remote control) 270 designed for external control and monitoring during operation. Operator can use the following commands to control: POWER (turn on the power supply), POWER OFF (turn off the power supply), RETURN (smooth return of the rings to the initial position), RUN (play game), STOP (prohibit the operation of servo drivers (shown in FIG. 4) while maintaining the general power supply).

According to embodiments of the present invention, the apparatus 100 can rotates the user 360 degrees in any direction. More specifically, the gearbox 83 that is mounted on the first stand 2 rotates the outer ring 3. The second gearbox 84 located on bottom of the middle ring 4 rotates the middle ring 4. The side gearbox 89 mounted on the cabin 5 rotates the cabin 5. That is, the rotation of the rings 3, 4 and/or the cabin 5 can be carried out 360 degrees in any direction independently and does not depend on the position of other components of the apparatus 100. That is, the outer ring 3 can be rotated in the opposite axial and/or radial directions than the middle ring 4.

According to embodiments of the present invention, the apparatus 100 can also can determine the user's height by way of a system suitable for measuring height, weight and other parameters of the user, for example, by providing sensory system for such measurements on the frame 1. Based on the measurements the user can be admitted or not admitted to operate the apparatus 100. For example, if the user does not fit the predetermined parameters, the red indicator on the apparatus 100 can light up indicating that the user has not met the parameters for using the apparatus 100. If the user has met the parameters, the user can proceed to a specifically designated scale (not shown) included on the frame 1, where the user is weighed. If a corresponding weight indicator lights up thereby allowing the user to proceed to the seat 96. A weight sensor (not shown) can also be installed in the seat 96. The weight sensor can detect the presence of the user on the seat 96. The user than allowed to fasten a waist belt (not shown). The waist belt can include a sensor (not shown) that is triggered by a safety system. The user than allowed to set a restraint 55 in such a position that it is presses on the abdominal region of the user in the direction of the seat 96. The restraint 55 can be an over-the-shoulder restrain, roll cage, safety arch or the like. An adjustment of the restraint 55 can be carried out by means of the ratchet mechanism installed in the cabin 5. After fixing the restraint 55 in a “play position,” the mechanical blocking located on the frame 17 and the fixed position of the middle and outer rings 3, 4 and the cabin 5 is removed. Then, the user can put on a virtual reality (VR) device 88 located in the cabin 5 and begin using the apparatus 100.

FIG. 4 is a flow diagram illustrating a control system 200 that can be used with the apparatus 100 for providing the user with a 360 degrees rotational movement in three planes, independently, and experiencing the feeling of riding, for example, an aircraft, motorcycling, or combat robot. The control system 200 includes a plurality of servo drivers 210 that control the movement of the middle and outer rings 3, 4 and the cabin 5 around the axes.

Each of the servo drivers 210 is controlled by its own driver board 220 for each axis (X, Y, and Z). Each driver board 220 is controlled by a computer program (master) (290) via an interface installed on the VR device 88. The master program 290 is an intermediate link between content 230 and the driver boards 220 of the servo drivers 210 of the control system 200, carrying out, receiving, processing and sending data both from the content 210 to the driver boards 220 and from the driver boards 220 to the content 210, as well as to synchronizing the spatial position of the axes (X, Y, Z) of the apparatus with the virtual spatial position of the user in the content 230 at a given point in time. The driver boards 220 (X, Y, Z axes) transmit parameters to the servo driver 210, for example, speed, positioning, enable/disable, alarm and the like. The driver boards 220 receive data, which correspond to the current parameters of the applicable servo driver 210 (speed, positioning, enable, disable, alarm), to transfer such data to the master program 290. Each servo driver 210 can include an electric motor, an encoder and a controllable power module. Each servo driver 210 generates torque on the shaft of the electric motor for subsequent transmission of torque to the gearbox. The torque corresponds to the value given by the driver boards 220.

The content 230 creates and shares information data for the VR device 88 and the master program 290.

The VR device 88 can be any suitable VR system that can include, for example, a helmet, joysticks, microphone and hearing components. The VR device 88 can receive data from the content 230 with visualization (e.g., audio and video) effects translated into a VR helmet of the VR device 88.

To synchronize the spatial position of the axes (X, Y, Z) of the apparatus 100 with a virtual spatial position of the user in the content 230 at a given point in time, the master program reads information from a accelerometer board and transfers the information to the content 230.

The exchange of data between the content 230 and the apparatus 100 can be carried out, for example, using the User Datagram Protocol (UDP).

Electrical safety is ensured by current protection (overload, short circuit) and Ground Fault Interrupter (residual-current device, RCD). Protection against access to the area of rotating rings 3, 4 is provided by a safeguard. For monitoring by the control system 200, various sensors connected to the control system 200 and apparatus 100 can be provided in the seat belts, safety bar, and safeguard.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A virtual hyper-reality apparatus, the apparatus comprising:
a frame having a first stand and a second stand, the first stand having a first gearbox with a first shaft, the second stand having a first axle;
an outer ring is mounted between the first shaft and the first axle, the outer ring having a second shaft and a top axle mounted opposite to the second shaft;
a middle ring is mounted between the second shaft and the top axle, the middle ring having a second gearbox with a third shaft and a third axle positioned opposite to the third shaft of the middle ring; and
a cabin for a user is mounted between the third axle and the third shaft, wherein the apparatus is configured to rotate the user 360 degrees in three planes, independently.

2. The apparatus according to claim 1 further comprising a control system, wherein the control system comprises:
a plurality of servo drivers for controlling the movement of the outer ring, the middle ring and the cabin;
a plurality of driver boards for controlling each servo driver of the plurality of the servo drivers;
a master program for carrying out, receiving, processing and sending a content data to the plurality of driver boards and from the plurality of driver boards to a content, and based on the content data, the master program synchronizes a spatial position of the axes (X, Y, Z) of the apparatus with a virtual spatial position of the user in the content at a given point in time.

3. The apparatus according to claim 2, wherein each servo driver is controlled by one of the driver board for each axis (X, Y, Z).

4. The apparatus according to claim 2, wherein each servo driver comprises an electric motor, an encoder, and a controllable power module.

5. The apparatus according to claim 2, wherein the content is a computer game software.

6. The apparatus according to claim 1, wherein the cabin comprises a virtual reality (VR) device.

7. The apparatus according to claim 1, wherein the cabin comprises a seat.

8. The apparatus according to claim 1, wherein the frame includes a plurality of movable platforms configured to mechanically fix the outer ring in a fixed position thereby allowing the user to enter the cabin.

9. The apparatus according to claim 1 further comprising an operator panel.

10. A virtual hyper-reality apparatus for motion simulation, the apparatus comprising:
a frame;
an outer ring operably mounted on top of the frame and configured to rotate around the vertical axis;
a middle ring operably mounted within the outer ring and configured to rotate around the horizontal axis; and
a cabin for a user operably mounted within the middle ring configured to rotate 360 degrees in three planes, independently.

11. The apparatus according to claim 10 further comprising a control system, wherein the control system is configured to synchronizes the spatial position of the axes (X, Y, Z) of the apparatus with a virtual spatial position of the user in a content at a given point in time.

12. The apparatus according to claim 11, wherein the content is a computer simulation software or a computer game software.

13. The apparatus according to claim 10, wherein the cabin comprises a virtual reality (VR) device

14. The apparatus according to claim 10, wherein the cabin comprises a seat.

15. The apparatus according to claim 10, wherein the frame includes a plurality of movable platforms configured to mechanically fix the outer ring in a fixed position thereby allowing the user to enter the cabin.
